(19) United States
(12) Patent Application Publication
(10) Pub. No.: US 2005/0182861 A1
(43) Pub. Date: Aug. 18, 2005

(54) Authentication packet for communications

(76) Inventor: Christopher Hentschel, Kingston, MA (US)

Correspondence Address: STEVEN N. FOX, ESQ., P.O. BOX 251, CANTON, MA, 02021, US

(21) Appl. No.: 10/982,690

(22) Filed: Nov. 4, 2004

Related U.S. Application Data
(60) Provisional application No. 60/517,251, filed on Nov. 4, 2003.

(51) Int. Cl. G06F 3/00

(52) U.S. Cl. 710/16

(57) ABSTRACT

The present invention is a communications system comprising a host device and an external device or product having a 4 byte Product ID. The host device is adapted to poll the external device to determine the Product ID of the external device. The external device is adapted to transmit its 4 byte Product ID to the host device in response to the Product ID Request from the host device. The host device is adapted to generate a packet having an authentication command 0×1 F followed by a pair of CRC bytes having a CRC_HI byte and a CRC LO byte. The pair of CRC bytes take into account the 4 byte Product ID and the authentication command 0×1 F when generating an overall value. The 4 byte Product ID is not contained in the packet. The host device 12 is further adapted to transmit the packet to the external device 14. The external device is further adapted to authenticate the packet, and if authenticated, provide the host device with full command and control of the external device 14. When authenticating, the external device knows and includes the fact that the value generated by the pair of CRC bytes has taken into consideration the value represented by the 4 byte Product ID.

### CROSS-REFERENCE TO RELATED APPLICATIONS

This application claims priority to U.S. Provisional Application Ser. No. 60/517,251 filed on Nov. 4, 2003.

### BACKGROUND OF THE INVENTION

It is possible today to reverse engineer the protocols and commands used to control products. An unique system and/or method is needed to authenticate that the owner of the software is in fact the person attempting to establish communications with the connected device.

### SUMMARY OF THE INVENTION

The present invention is a communications system comprising a host device and an external device having an arbitrary assigned product identification code which in one embodiment is a production identification code having 4 bytes (the “4 Byte Product ID”). The host device is adapted to poll the external device to determine the 4 Byte Product ID of the external device. In response to the polling from the host device, the external device is adapted to transmit the 4 Byte Product ID to the host device. The host device is adapted to generate a packet structure having an authentication command 0×1F followed by a pair of CRC bytes. The pair of CRC bytes are adapted to generate a sum check value taking into consideration the value associated with 4 Byte Product ID and the authentication command 0×1F without the specific 4 Byte Product ID being included in the packet. The host device is further adapted to transmit the packet to the external device. The external device is further adapted to authenticate the packet, and if authenticated, to provide the host device with full command and control of the external device by fully opening the communications channel. When authenticating, the external device knows and includes the fact that the value generated by the pair of CRC bytes had taken into account the value associated with the 4 Byte Product ID.

### BRIEF DESCRIPTION OF THE DRAWINGS

The description of the invention will be more fully understood with reference to the accompanying drawings wherein:

FIG. 1 is a high level block diagram showing the architecture of the present invention; and

FIG. 2 is a high level flow chart showing the operation of the present invention.

### DETAILED DESCRIPTION OF THE INVENTION

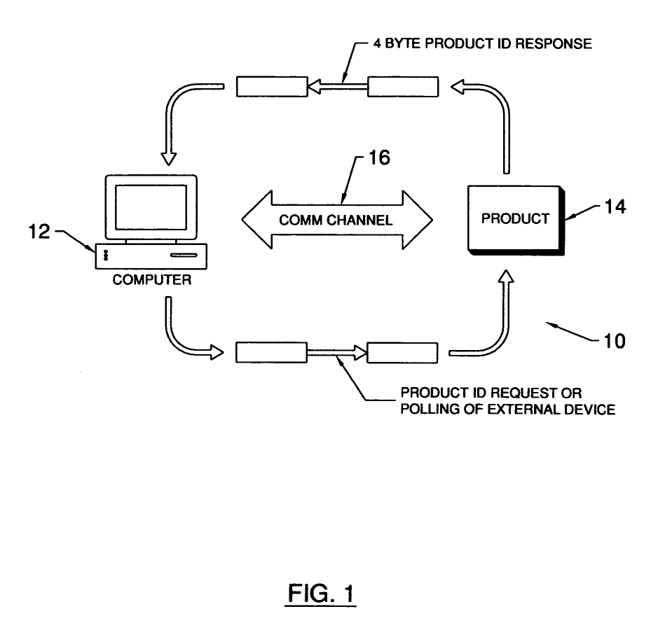

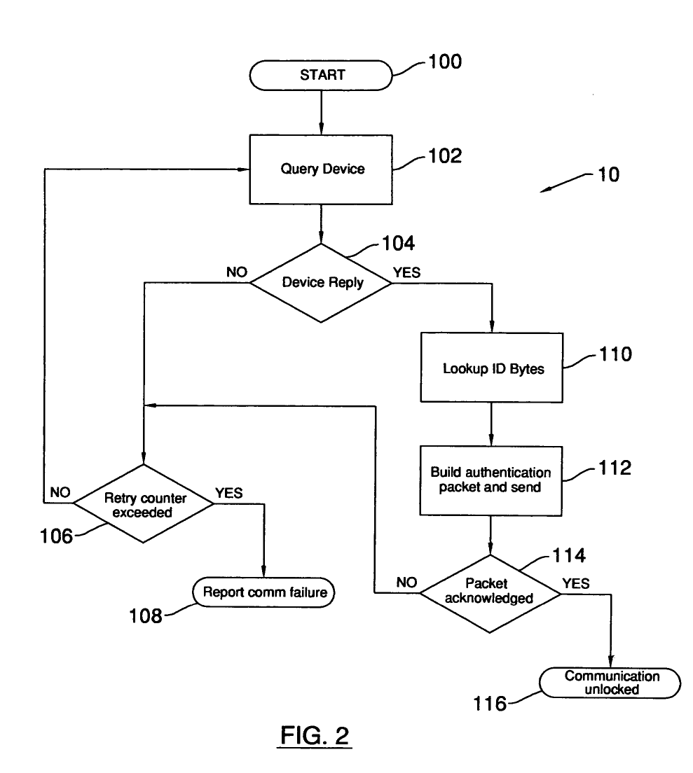

Referring to FIG. 1-2, the present invention relates to a unique communications system 10 and method used to authenticate and authorize communication between software of a host system or device 12 such as personal computer and a connected external device or product 14 such as an access control system mounted on a door or to unlock machinery such as a truck. More particularly, the present invention 10 provides a means to insure that the communicating software of the host system 12 is authorized to control the external or target device 14. The host device 10 may be any type of communications device such as a computer system. The external device 14 may be any type of external device adapted to support data exchange. The external device 12 has a product identification code designated by 4 bytes (the “4 Byte Product ID”). For example, the external device 14 may be an access control device for controlling access thru an entry way which may be mounted in close proximity to a door. The host device 12 is adapted to poll the external device 14 for its 4 Byte Product ID. In response to the polling, the external device 14 is adapted to transmit the 4 byte Product ID to the host device 12. The host device 12 is adapted to build or generate a packet (to be described) comprising an authentication command of 0×1F and following the packet a pair of CRC bytes having a CRC_HI byte and a CRC LO byte. The pair of CRC bytes are adapted to generate a sum check value taking into account the value associated with the 4 Byte Product ID and the value associated with the authentication command. The host device 12 is further adapted to transmit the packet to the external device 14. The external device 14 is further adapted to authenticate the packet and provide the host device 12 with full command and control of the external device 14, if authenticated.

The packet structure is defined as an asynchronous, half or full duplex, byte oriented protocol with 1 start bit, 8 data bits, 1 stop bit, no parity bit and a default data rate of 19200 bits per second. All commands and data are sent in a size delimited packet format consisting of the following fields:

[SOP|˜SOP|DEV|ML_HI|ML_LO|MESSAGE|CRC_HI|CRC_LO]

| | |
|---|---|
| SOP | start of packet (0 × 24) |
| ˜SOP | one's compliment of start of packet (0 × DB) |
| DEV | device address |
| ML_HI | message length (most significant byte) |
| ML_LO | message length (least significant byte) |
| MESSAGE | variable length block containing command byte and |
| | parameter data |
| CRC_HI | most significant byte of packet CRC excluding the two |
| | SOP bytes |
| CRC_LO | least significant byte of packet CRC excluding the two |
| | SOP bytes |

At the heart of this packet structure is a variable length data block referred to as the “message.” This data block contains the information to be transferred between the host and target devices. The general format of the message block is a single command byte followed by zero or more parameter bytes. The last 16 command bytes (0×F0 through 0×FF) have been reserved for future protocol expansion.

All packets conforming to this structure should be responded to by the receiving device within 100 milliseconds. A lack of response indicates an error and the transmitting device should retry the command. After a number of consecutive retries (usually 3) the addressed device should be considered faulty.

The cyclic redundancy check (CRC) implemented in this protocol is the CRC commonly referred to as CRC-CCITT with the polynomial representation of: X¹⁶+X¹²+X⁵+1. The CRC result is initialized to 0×FFFF prior to processing packet data.

The packet is used to authenticate the host to the product to allow full communications. It is designed to be unique and include information that is unique to the specific product and known to the host system. If this information is conveyed to the product in the authentication packet then the communication channel is opened on the product side.

In operation, the connected device 14 is polled to allow identification of the connected device 14. The host system 12 then sends the authentication packet, which includes in the check sum 4 bytes of product information known to the host system 12. These additional bytes while included in the check sum are not included in the packet. The packet is identified with the message portion starting with the byte 0×1F.

[0 × 24|0 × DB|DEV|0 × 00|0 × 01|0 × 1F|
CRC_HI|CRC_LO]

| | |
|---|---|
| SOP | start of packet (0 × 24) |
| ˜SOP | one's compliment of start of packet (0 × DB) |
| DEV | device address (0 × 01 to 0 × FF) |
| ML_HI | message length (0 × 00) |
| ML_LO | message length (0 × 01) |
| CRC_HI | most significant byte of packet CRC excluding the two |
| | SOP bytes but including the 4 product identification bytes |
| CRC_LO | least significant byte of packet CRC excluding the two |
| | SOP bytes but including the 4 product identification bytes. |

Unlike conventional communications systems, the use of the packet of the present invention prevents unauthorized software from establishing communications with a device. The packet of the present invention may be used with hard-wired or wireless communications, or any type of other presently developed and/or futurely developed communications system. The present invention may be embodied in other specific forms without departing from the spirit or essential characteristics thereof.

1. A communications system comprising: a host device and an external device; said external device having a 4 byte Product ID; said host device being adapted to transmit a Product ID Request to said external device; said external device being adapted to transmit said 4 byte Product ID to said host device in response to said Product ID Request from said host device; said host device being adapted to generate a packet comprising an authentication command followed by a pair of CRC bytes; said pair of CRC bytes are adapted to generate a check sum taking into consideration the value of said 4 byte PRODUCT ID even though said 4 byte Product ID is not in said packet; said host device being adapted to transmit said packet to said external device; said external device being adapted to authenticate said packet by taking into account that said check sum value generated by said pair of CRC bytes takes into consideration said value associated with said 4 byte Product ID; and if authenticated, to provide said host device with command and control of said external device.

2. The system of claim 1, wherein said packet further comprises a message byte having an authentication command of 0×1F and said check sum generated by said pair of CRC bytes takes into consideration the value of said 4 byte PRODUCT ID and said value associated with said authentication command of 0×1F.

3. The system of claim 2, wherein said host device is a communication device.

4. The system of claim 3, wherein said host device is a host computer system.

5. The system of claim 4, wherein said external device is adapted to support data exchange.

6. The system of claim 5, wherein said external device is an access control device for controlling access thru an entry way.

5. A method for communicating between a host device and an external device to ensure that the host system is authorized to control the external device, the method comprising the steps of:
a) polling the external device for a 4 Byte Product ID;
b) transmitting said 4 Byte Product ID to the host device in response to said step of polling the external device;
c) building a packet comprising an authentication command;
d) generating a check sum value using a pair of CRC bytes based upon the values associated with both said authentication command and said 4 Byte Product ID;
e) transmitting said packet and said check sum value to said external device for authentication;
f) authentication of said packet by said external device taking into account that said check sum value was determined based upon both said authentication command and said 4 Byte Product ID; and
g) providing said host device with command control of said external device if said packet is authenticated.
